(19) United States
(12) Patent Application Publication
(10) Pub. No.: US 2025/0214342 A1
(43) Pub. Date: Jul. 3, 2025

(54) PRINTING APPARATUS

(71) Applicant: BROTHER KOGYO KABUSHIKI KAISHA, Nagoya (JP)

(72) Inventors: Mitsutoshi NISHIWAKI, Ichinomiya (JP); Yohei KUNO, Nagoya (JP); Yoshinori KATO, Nagoya (JP)

(21) Appl. No.: 19/002,220

(22) Filed: Dec. 26, 2024

(30) Foreign Application Priority Data
Dec. 27, 2023 (JP) 2023-220968

(51) Int. Cl. B41J 2/165

(52) U.S. Cl. CPC B41J 2/16508; B41J 2/16579; B41J 2002/16594

(57) ABSTRACT

A printing apparatus includes: a switching mechanism; a first cleaning portion configured to execute first cleaning; and a control device. The control device switches a liquid contacting state to a liquid un-contacting state by the switching mechanism, detects an ejection failure of at least one of nozzles in a nozzle surface after the switching to the liquid un-contacting state, determines whether the first cleaning is necessary based on a detection result, causes the first cleaning portion to execute the first cleaning when it is determined that the first cleaning is necessary, and does not cause the first cleaning portion to execute the first cleaning when it is determined that the first cleaning is unnecessary.

### REFERENCE TO RELATED APPLICATIONS

This application claims priority from Japanese Patent Application No. 2023-220968 filed on Dec. 27, 2023. The entire contents of these priority applications are incorporated herein by reference.

### BACKGROUND ART

In a related art, there is a printing apparatus that executes tube cleaning processing by moving a cap to a nozzle forming surface sealing position and driving a suction pump. As the tube cleaning processing, the printing apparatus causes an ink solution in a solution tank to flow into the cap via an atmosphere communication tube and then to be discharged to a waste ink tank. Further, this literature discloses that maintenance processing is executed in which the suction pump is driven to generate a negative pressure in the cap, thereby forcibly discharging an ink in the nozzle into the cap.

In order to avoid occurrence of an ejection failure in the nozzle on a nozzle surface, processing of reducing thickening of the ink in the nozzle by bringing the nozzle surface into contact with cleaning liquid may be executed at the time of non-ejection when ink ejection is not executed. After the nozzle surface is brought into contact with the cleaning liquid, a purge may be executed to forcibly discharge the cleaning liquid entering the nozzle as the maintenance processing. However, in a method of forcibly discharging the ink by the suction pump as in the printing apparatus of the related art, the amount of the ink discharged from the nozzle increases, and consumption of the ink increases.

### SUMMARY

An object of the present disclosure is to provide a printing apparatus capable of suppressing consumption of an ink.

A printing apparatus according to the present disclosure includes: an ejection head having a nozzle surface provided with a plurality of nozzles; a switching mechanism configured to switch between a liquid contacting state in which a predetermined liquid surface is in contact with the nozzle surface and a liquid un-contacting state in which the nozzle surface is separated from the liquid surface during non-ejection when an ink is not ejected from the nozzles; a first cleaning portion configured to execute first cleaning, which is cleaning for improving an ejection function of the nozzles; and a control device. The control device switches the liquid contacting state to the liquid un-contacting state by the switching mechanism, detects an ejection failure of at least one of the nozzles in the nozzle surface after the switching to the liquid un-contacting state, determines whether the first cleaning is necessary based on a detection result, causes the first cleaning portion to execute the first cleaning when it is determined that the first cleaning is necessary, and does not cause the first cleaning portion to execute the first cleaning when it is determined that the first cleaning is unnecessary.

According to the present disclosure, when it is determined that the first cleaning is necessary based on the detection result of the ejection failure of the nozzle, the first cleaning is executed, and when it is determined that the first cleaning is unnecessary, the first cleaning is not executed. Accordingly, the amount of the ink discharged from the nozzle is reduced compared with a case where the first cleaning is executed regardless of the presence or absence of the ejection failure of the nozzle after the liquid contacting state in which thickening of the ink in the nozzle is suppressed is switched to the liquid un-contacting state.

### BRIEF DESCRIPTION OF DRAWINGS

A more complete appreciation of the disclosure and many of the attendant advantages thereof will be readily obtained as the same becomes better understood by reference to the following detailed description when considered in connection with the accompanying drawings.

FIG. 1 is a plan view of a printing apparatus according to an embodiment.

FIG. 2 is a block diagram showing a configuration of the printing apparatus of FIG. 1.

FIG. 3 is a diagram showing a configuration for forming a liquid contacting state and a covered state.

FIG. 4A is a view showing the liquid contacting state and the covered state, and FIG. 4B is a view showing a liquid un-contacting state and a non-covered state.

FIG. 5 is a diagram showing a configuration for executing ejection failure detection processing.

FIG. 6A is a diagram showing a change in a voltage value of a detection electrode when an ink is ejected from a nozzle, and FIG. 6B is a diagram showing a change in the voltage value of the detection electrode when the ink is not ejected from the nozzle.

FIG. 7 is a flowchart showing a processing flow of first cleaning and second cleaning in the printing apparatus.

### DESCRIPTION

Hereinafter, a printing apparatus according to an embodiment of the present disclosure will be described with reference to the drawings. The printing apparatus described below is merely an embodiment of the present disclosure. Accordingly, the present disclosure is not limited to the following embodiment, and can be added, deleted, or modified without departing from the scope of the present invention.

As used herein, the words “a” and “an” and the like carry the meaning of “one or more.” When an amount, concentration, or other value or parameter is given as a range, and/or its description includes a list of upper and lower values, this is to be understood as specifically disclosing all integers and fractions within the given range, and all ranges formed from any pair of any upper and lower values, regardless of whether subranges are separately disclosed. Where a range of numerical values is recited herein, unless otherwise stated, the range is intended to include the endpoints thereof, as well as all integers and fractions within the range. As an example, a stated range of 1-10 fully describes and includes the independent subrange 3.4-7.2 as does the following list of values: 1, 4, 6, 10.

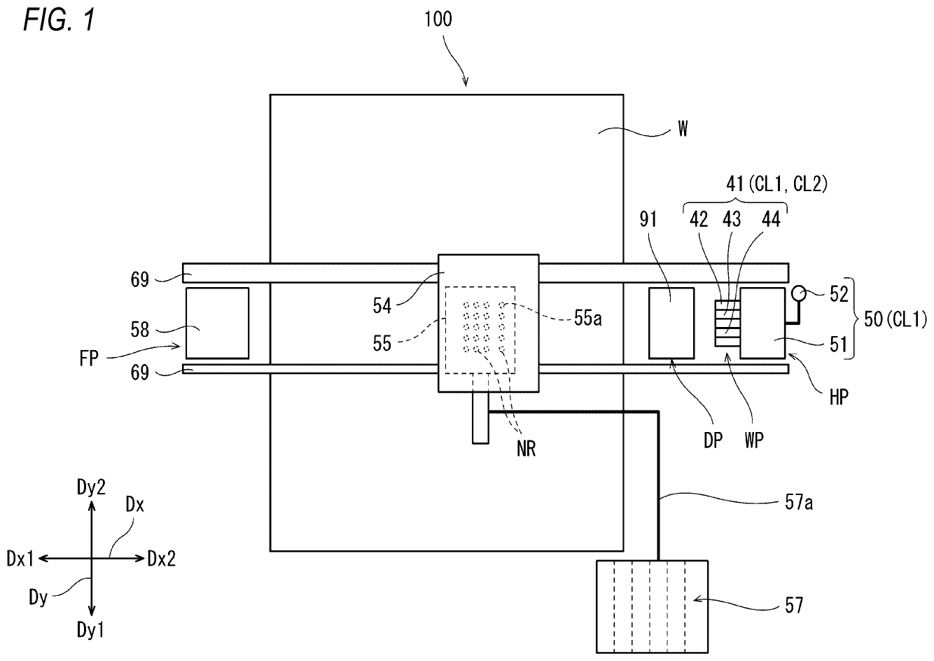

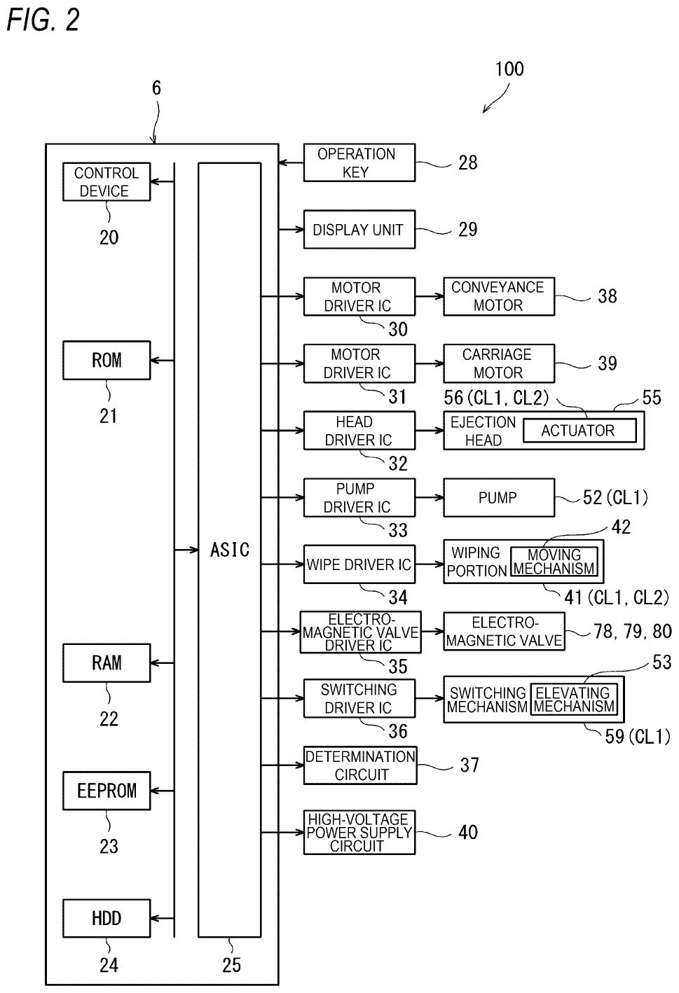

FIG. 1 is a plan view of a printing apparatus 100 according to an embodiment of the present invention. FIG. 2 is a block diagram showing a configuration of the printing apparatus 100 of FIG. 1. In FIG. 1 and each of the drawings to be described later, directions orthogonal to one another are referred to as a first direction Dx, a second direction Dy, and a third direction Dz. The first direction Dx is, for example, a left-right direction (a main scanning direction), the second direction Dy is, for example, a front-rear direction, and the third direction Dz is, for example, an upper-lower direction. One side of the first direction Dx is denoted by Dx1, and a direction opposite to the direction Dx1 is denoted by Dx2. One of the second directions Dy is defined as a conveyance direction Dy1, and a direction opposite to the direction Dy1 is defined as a direction Dy2. One of the third directions Dz is denoted by Dz1, and a direction opposite to the direction Dz1 is denoted by Dz2. However, all of the above directions are examples and are not limited.

The printing apparatus 100 in FIG. 1 executes printing by ejecting ink droplets of an ink onto a print medium W such as a printing sheet and a fabric. The printing apparatus 100 prints a color image by ejecting ink droplets of yellow (Y), magenta (M), cyan (C), and black (K) inks, which are collectively referred to as color inks, onto the print medium W. Further, in a case of printing the color image on the fabric serving as the printing medium W, for example, ink droplets of white (W) are first ejected as a base ink in order to reduce an influence on a color and a material of the fabric, and the ink droplets of the color inks are ejected on the ink droplets.

As shown in FIG. 1, the printing apparatus 1 includes storage tanks 57, an ejection head 55, a carriage 54, and a pair of guide rails 69. The carriage 54 supports the ejection head 55. The carriage 54 is supported by the pair of guide rails 69 extending in the first direction Dx, and reciprocates in the first direction Dx along the guide rails 69. Accordingly, the ejection head 55 reciprocates in the first direction Dx. The ejection head 55 is connected to the storage tanks 57 via a tube 57a. In printing processing, the control device 20 causes the ejection head 55 to eject ink droplets onto the print medium W while causing the carriage 54 to move the ejection head 55 in the direction Dx1 or Dx2, thereby forming dots along the first direction Dx. Then, after the dots are formed, the control device 20 causes the print medium W to be conveyed by a predetermined distance in the conveyance direction Dy1 by a platen (not shown). By repeating the dot formation and the conveyance operation, a predetermined image is formed on the print medium W.

The ejection head 55 includes, for example, a plurality of nozzles 55a that eject ink droplets of respective colors of the color inks onto the print medium W. The plurality of nozzles 55a are provided on a nozzle surface 55b to be described later of the ejection head 55. The plurality of nozzles 55a form a nozzle array NR for each color along the second direction Dy. When the ink droplets of the four colors are ejected onto the print medium W, the color image is printed on the print medium W. Although not shown in FIG. 1, an ejection head (hereinafter, referred to as a white ink ejection head) that ejects ink droplets of white (W) may be provided in the carriage 54. In this case, the ejection head 55 and the white ink ejection head may be disposed to be separated from each other in the second direction Dy in one carriage 54. Alternatively, the ejection head 55 and the white ink ejection head may be disposed to be separated from each other in the first direction Dx in one carriage 54. Further, a carriage that supports the white ink ejection head may be provided separately from the carriage 54 that supports the ejection head 55. The numbers and positions of caps 51 and cap portions 91, which will be described later, may be changed according to a positional relationship between the plurality of ejection heads.

The ink is stored in the storage tank 57. The storage tank 57 is provided for each type of the ink. For example, five storage tanks 57 are provided, and each storage tank 57 stores any ink of cyan, magenta, yellow, black, and white inks.

The printing apparatus 1 further includes a wiping portion 41, a pump 52, a switching mechanism 59 to be described later, a receiving portion 58, and the cap portion 91.

The wiping portion 41 is disposed between the pair of guide rails 69 on one side in the first direction Dx so as to overlap a movement region of the carriage 54. The wiping portion 41 includes wipers 43 and 44 and a moving mechanism 42. The moving mechanism 42 includes, for example, a motor, a ball screw, or a rack-and-pinion, and supports the wipers 43 and 44. In a state where the nozzle surface 55b is disposed at a position facing the wipers 43 and 44, for example, the moving mechanism 42 moves in the second direction Dy or the first direction Dx, or the carriage 54 moves in the first direction Dx. Accordingly, the wipers 43 and 44 wipe the nozzle surface 55b, thereby cleaning the nozzle surface 55b. A position of the ejection head 55 when the nozzle surface 55b faces the wipers 43 and 44 is referred to as a wipe position WP. The wiping by the wiping portion 41 is included in first cleaning and second cleaning to be described later.

The switching mechanism 59 includes the cap 51 and an elevating mechanism 53 to be described later. The cap 51 is disposed between the pair of guide rails 69 so as to overlap the movement region of the carriage 54. The elevating mechanism 53 includes, for example, a motor, a ball screw, a rack-and-pinion, or the like, and is connected to the cap 51. When the elevating mechanism 53 is driven, the cap 51 reciprocates in the third direction Dz. Details of the switching mechanism 59 will be described later.

The pump 52 supplies a liquid (for example, a cleaning liquid) into the cap 51 when liquid contacting processing to be described later is executed. Further, the pump 52 generates a negative pressure in the cap 51 at the time of executing a purge to be described later, thereby suctioning air in the cap 51, the ink and the cleaning liquid in the nozzles 55a.

The cap portion 91 is disposed between the pair of guide rails 69 so as to overlap the movement region of the carriage 54. The cap portion 91 receives the ink droplets ejected from the nozzles 55a in a state where the nozzle surface 55b of the ejection head 55 is disposed at a position facing the cap portion 91. The position of the ejection head 55 when the nozzle surface 55b faces the cap portion 91 is referred to as a detection position DP. When the ejection head 55 is disposed at the detection position DP, an ejection failure of the nozzle 55a is detected based on whether the ink droplets are ejected. The ejection failure detection processing will be described in detail later. In the present embodiment, a mode in which the cap portion 91 is provided separately from the cap 51 has been described, but is not limited thereto. The cap portion 91 may not be provided as long as the ejection failure detection processing to be described in detail later is executed using the cap 51 at a standby position HP to be described later. In this case, a detection electrode 92 to be described later is disposed in the cap 51.

The receiving portion 58 is disposed between the pair of guide rails 69 on the other side in the first direction Dx so as to overlap the movement region of the carriage 54. The receiving portion 58 receives ink droplets ejected from the nozzles 55a during non-printing in a state in which the nozzle surface 55b of the ejection head 55 is disposed at a position facing the receiving portion 58. The position of the ejection head 55 when the nozzle surface 55b is disposed to face the receiving portion 58 is referred to as a flushing position FP. Processing of ejecting the ink droplets from the nozzle 55a at the flushing position FP is referred to as flushing. The flushing is included in the first cleaning and the second cleaning to be described later.

Next, as shown in FIG. 2, the printing apparatus 100 includes an operation key 28, a display unit 29, a controller unit 6, motor driver ICs 30 and 31, a head driver IC 32, a pump driver IC 33, a wipe driver IC 34, an electromagnetic valve driver IC 35, a switch driver IC 36, a determination circuit 37, and a high-voltage power supply circuit 40. The printing apparatus 100 further includes a conveyance motor 38, a carriage motor 39, and electromagnetic valves 78, 79, and 80.

The operation key 28 receives an operation input by a user. The display unit 29 includes, for example, a touch panel and displays predetermined information. A part of the display unit 29 may function as the operation key.

The controller unit 6 implements a printing function based on an input from the operation key 28 or an external input, and controls the display of the display unit 29. The controller unit 6 includes a ROM 21, a RAM 22, an EEPROM 23, an HDD 24, an ASIC 25, and a control device 20 implemented by a CPU. The control device 20 is electrically connected to the ROM 21, the RAM 22, the EEPROM 23, the HDD 24, and the ASIC 25, and controls the driver ICs 30 to 36, the determination circuit 37, and the high-voltage power supply circuit 40.

The control device 20 executes various functions by executing a printing program stored in the ROM 21. The control device 20 may be implemented as one processor in the controller unit 6, or may be implemented as a plurality of processors that cooperate with one another. The printing program may be read by a reading device from a recording medium such as a computer-readable magneto-optical disk or a USB flash memory and stored in the ROM 21.

The RAM 22 stores image data received from the outside, a calculation result of the control device 20, and the like. The EEPROM 23 stores various types of initial setting information input by the user, a cumulative value of the number of printed sheets, and the like. The HDD 24 stores various data and the like.

The driver ICs 30 to 36, the determination circuit 37, and the high-voltage power supply circuit 40 are connected to the ASIC 25. The control device 20 outputs various commands including a print command based on the printing program to the ASIC 25. The ASIC 25 drives the driver ICs 30 to 36, the determination circuit 37, and the high-voltage power supply circuit 40 based on the various commands. A mode in which the operation keys 28, the display unit 29, and the driver ICs 30, 31, and 33 to 36 are directly connected to the control device 20 may be adopted. The determination circuit 37 and the high-voltage power supply circuit 40 will be described in detail later.

The conveyance motor 38 is connected to a platen (not shown) that supports the print medium W. When the conveyance motor 38 is driven by the motor driver IC 30, the platen reciprocates in the second direction Dy. When the platen reciprocates in the second direction Dy, the print medium W placed on the platen is conveyed in the second direction Dy (that is, the conveyance direction Dy1 and the direction Dy2). The carriage motor 39 is connected to the carriage 54. When the carriage motor 39 is driven by the motor driver IC 31, the carriage 54 reciprocates in the first direction Dx. Accordingly, the ejection head 55 reciprocates in the first direction Dx. The head driver IC 32 applies an ejection pressure to a pressure chamber (not shown) by an actuator 56 provided in the ejection head 55. Accordingly, the ink droplets are ejected from the nozzle 55a. The actuator 56 is included in a first cleaning portion CL1 that executes the first cleaning and a second cleaning portion CL2 that executes the second cleaning, which will be described later.

The pump driver IC 33 controls a suction operation of the pump 52. A moving operation of the moving mechanism 42 of the wiping portion 41 is controlled by the wipe driver IC 34. The electromagnetic valve driver IC 35 controls opening and closing operations of the electromagnetic valves 78, 79, and 80. Further, the switching driver IC 36 controls an elevating operation of the elevating mechanism 53 of the switching mechanism 59. The pump 52 and the switching mechanism 59 are included in the first cleaning portion CL1 that executes the first cleaning to be described later, and the wiping portion 41 is included in the first cleaning portion CL1 that executes the first cleaning to be described later and the second cleaning portion CL2 that executes the second cleaning to be described later.

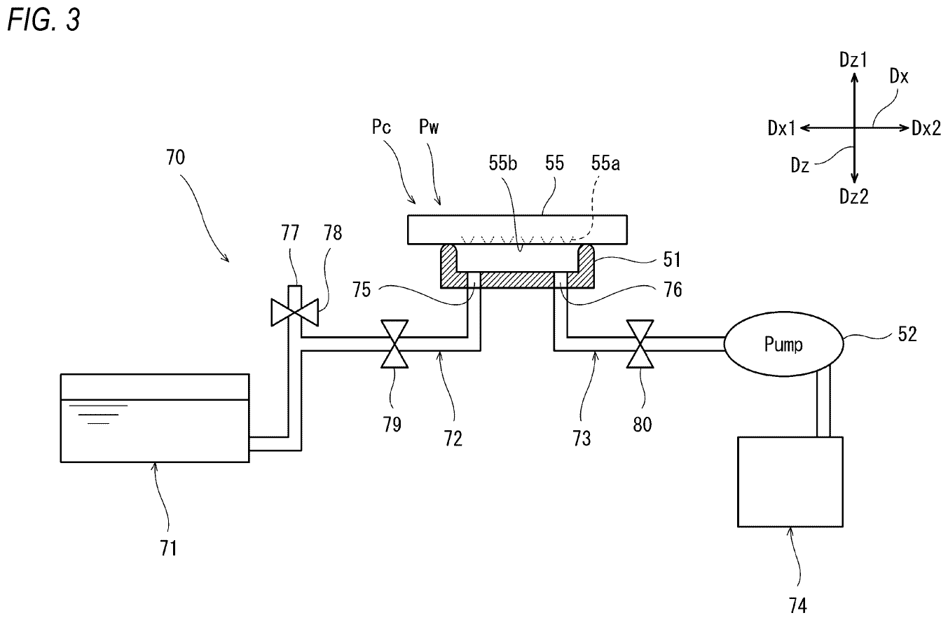

FIG. 3 is a diagram showing a configuration for forming a liquid contacting state and a covered state. As shown in FIG. 3, the printing apparatus 100 includes a supply and discharge portion 70. The supply and discharge portion 70 includes a cleaning liquid tank 71, a supply flow path 72, a discharge flow path 73, a liquid discharge tank 74, an atmosphere opening port 77, the above-described pump 52, and the above-described electromagnetic valves 78, 79, and 80.

The cleaning liquid tank 71 stores the cleaning liquid for cleaning the nozzle surface 55b. The supply flow path 72 connects the cleaning liquid tank 71 to the supply hole 75 provided in the cap 51, and supplies the cleaning liquid into the cap 51. The atmosphere opening port 77, the electromagnetic valve 78, and the electromagnetic valve 79 are provided in the supply flow path 72. The electromagnetic valve 78 opens and closes the atmosphere opening port 77. The electromagnetic valve 79 opens and closes the supply flow path 72.

The discharge flow path 73 connects a discharge hole 76 provided in the cap 51 to the liquid discharge tank 74, and discharges the ink and the cleaning liquid in the cap 51 to the liquid discharge tank 74. The electromagnetic valve 80 and the pump 52 are provided in the discharge flow path 73. The electromagnetic valve 80 opens and closes the discharge flow path 73. The pump 52 suctions the air in the cap 51 or the like, and the ink and the cleaning liquid forcibly discharged from the nozzle 55a at the time of executing the purge, and discharges them to the liquid discharge tank 74.

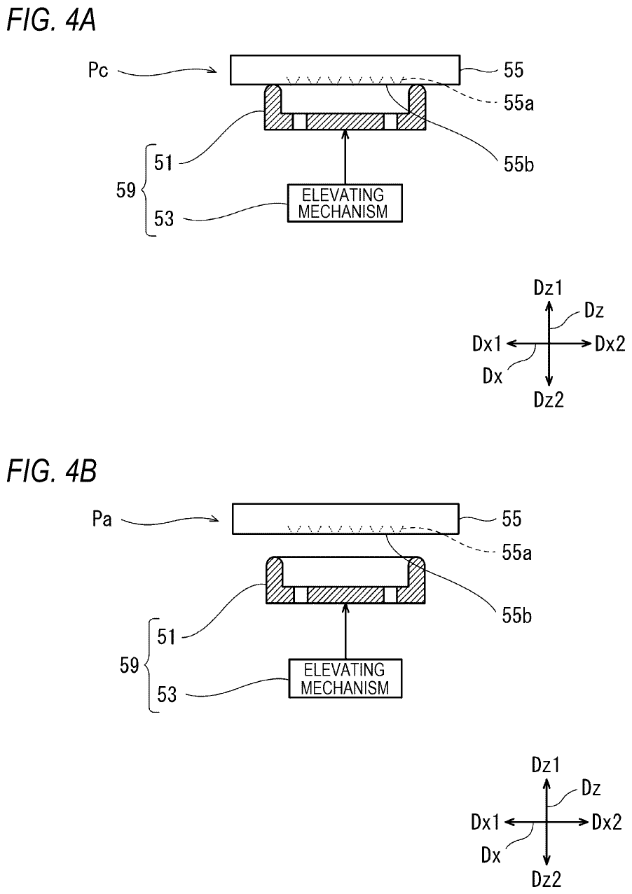

Here, in the printing apparatus 100, for the purpose of suppressing thickening of the ink in the nozzles 55a, for example, processing of bringing a liquid surface of the cleaning liquid into contact with the nozzle surface 55b (hereinafter, referred to as the liquid contacting processing) is executed at regular time intervals. Hereinafter, the liquid contacting processing will be described. FIG. 4A is a view showing the liquid contacting state and a covered state, and FIG. 4B is a view showing a liquid un-contacting state and a non-covered state.

The switching mechanism 59 switches between the liquid contacting state and the liquid un-contacting state after being moved to a position (hereinafter, referred to as the standby position HP) of the ejection head 55 when the nozzle surface 55b faces the cap 51 at the time of non-ejection (non-printing) in which ink droplets are not ejected from the nozzle 55a. In this case, the elevating mechanism 53 of the switching mechanism 59 is driven to move the cap 51 in the third direction Dz, thereby forming the liquid contacting state or the liquid un-contacting state. The liquid contacting state is a state in which a predetermined liquid surface is in contact with the nozzle surface 55b, and the liquid un-contacting state is a state in which the nozzle surface 55b is not in contact with the liquid surface.

When the liquid contacting processing is executed, the ejection head 55 is moved to the standby position HP. When the ejection head 55 moves to the standby position HP, as shown in FIG. 4B, the nozzle surface 55b of the ejection head 55 faces the cap 51 disposed at a position (hereinafter, referred to as an uncap position) Pa separated in the third direction Dz. Thereafter, as shown in FIG. 4A, the cap 51 is moved from the uncap position Pa to a cap position Pc by the elevating mechanism 53. Accordingly, the nozzle surface 55b is covered with the cap 51.

Then, the electromagnetic valve 78 is closed, the electromagnetic valves 79 and 80 are opened, and the pump 52 is driven. Accordingly, the cap 51 located at the cap position Pc is filled with the cleaning liquid in the cleaning liquid tank 71 through the supply flow path 72. As a result, the liquid contacting state in which the nozzle surface 55b is in contact with the liquid surface of the cleaning liquid is formed. In this way, the liquid contacting processing is executed. In order to maintain the state in which the nozzle surface 55b is in contact with the liquid surface of the cleaning liquid, the electromagnetic valve 78 is closed, the electromagnetic valves 79 and 80 are opened, and after a predetermined time has elapsed from the time when the pump 52 is driven, the electromagnetic valve 80 is closed, and the operation of the pump 52 is stopped.

After the liquid contacting processing is executed for a predetermined time, liquid discharge processing of the cleaning liquid is executed. In the liquid discharge processing, the electromagnetic valves 78 and 79 are opened to open the atmosphere opening port 77, so that the inside of the cap 51 is communicated with the atmosphere. Then, the electromagnetic valve 80 is opened, and the pump 52 is driven. Accordingly, the cleaning liquid in the cap 51 is discharged to the liquid discharge tank 74 via the discharge hole 76 and the discharge flow path 73. After the liquid discharge processing is completed, the cap 51 is moved from the cap position Pc to the uncap position Pa by the elevating mechanism 53. As a result, the liquid un-contacting state in which the nozzle surface 55b is not in contact with the liquid surface of the cleaning liquid is formed.

Further, the switching mechanism 59 moves the cap 51 in the third direction Dz when executing the processing (purge) of forcibly discharging the ink from the nozzle 55a by the suction operation of the pump 52 at the time of non-ejection (non-printing) when the ink droplets are not discharged from the nozzle 55a. The purge is included in the first cleaning to be described later.

When the purge is executed, the switching mechanism 59 switches between the covered state and the non-covered state after the ejection head 55 is moved to the standby position HP. In this case, the elevating mechanism 53 of the switching mechanism 59 is driven to move the cap 51 in the third direction Dz, thereby forming the covered state or the non-covered state. The covered state is a state in which the nozzle surface 55b is covered with the cap 51 when the purge is executed, and the non-covered state is a state in which the nozzle surface 55b and the cap 51 are separated from each other. As an example, in FIG. 4A, the position of the cap 51 when the covered state is formed is the same as the position of the cap 51 when the liquid contacting state is formed, and in FIG. 4B, the position of the cap 51 when the non-covered state is formed is the same as the position of the cap 51 when the liquid un-contacting state is formed.

When the ejection head 55 moves to the standby position HP during the purge, as shown in FIG. 4B, the nozzle surface 55b of the ejection head 55 faces the cap 51 disposed at the uncap position Pa. Thereafter, as shown in FIG. 4A, the cap 51 is moved from the uncap position Pa to the cap position Pc by the elevating mechanism 53. As a result, the covered state is formed in which the nozzle surface 55b is covered with the cap 51.

When the electromagnetic valves 78 and 79 are opened to open the atmosphere opening port 77, the inside of the cap 51 is communicated with the atmosphere. Then, the electromagnetic valve 80 is opened, and the pump 52 is driven. Accordingly, the ink from the nozzle 55a is discharged into the cap 51. In this way, the purge is executed. The ink discharged into the cap 51 is discharged to the liquid discharge tank 74 via the discharge hole 76 and the discharge flow path 73. After the purge is completed, the cap 51 is moved from the cap position Pc to the uncap position Pa by the elevating mechanism 53. As a result, the non-covered state in which the nozzle surface 55b and the cap 51 are separated from each other is formed.

Next, the first cleaning executed by the first cleaning portion CL1 and the second cleaning executed by the second cleaning portion CL2 will be described.

The first cleaning portion CL1 includes the actuator 56 that executes flushing, the pump 52 and the switching mechanism 59 that execute the purge, and the wiping portion 41 that executes wiping. The second cleaning portion CL2 includes the actuator 56 and the wiping portion 41.

The first cleaning executed by the first cleaning portion CL1 is cleaning for improving an ejection function of the nozzle 55a. The second cleaning executed by the second cleaning portion CL2 is cleaning for improving the ejection function of the nozzle 55a. The first cleaning includes a plurality of types of first cleaning. For example, the first cleaning includes the purge, flushing, and wiping described above. The purge as the first cleaning is executed in the liquid un-contacting state and the covered state after the non-covered state is switched to the covered state by the switching mechanism 59.

The second cleaning includes a plurality of types of second cleaning. For example, the second cleaning includes the flushing and the wiping described above. That is, as will be described later, the first cleaning includes cleaning that has a stronger improvement ability of the ejection function of the nozzle 55a than the second cleaning, and includes the same type of cleaning as that of the second cleaning. The second cleaning is executed by the second cleaning portion CL2 after the liquid contacting state is switched to the liquid un-contacting state by the switching mechanism 59 and before the ejection failure detection processing to be described in detail later is executed.

The first cleaning includes cleaning that has the stronger improvement ability of the ejection function of the nozzle 55a than the second cleaning. Specifically, the first cleaning includes the purge as the cleaning that has the stronger improvement ability of the ejection function of the nozzle 55a than the second cleaning.

The strength of the improvement ability may be defined by an ink consumption amount. For example, cleaning having a strong improvement ability is cleaning having a large ink consumption amount, and cleaning having a weak improvement ability is cleaning having a small ink consumption amount. Specifically, since wiping only wipes the nozzle surface 55b, the ink consumption amount is basically zero, but reliability of discharging the ink in the nozzles 55a is relatively low. Therefore, wiping can be said to be cleaning having a weak improvement ability. The flushing is to vibrate each nozzle 55a to discharge the ink in the nozzle 55a. Therefore, the amount of ink that may be discharged is smaller than that in the purge, and thus the ink consumption amount is smaller, but the discharge accuracy of the ink in the nozzle 55a is not higher than that in the purge. Therefore, the flushing can be said to be cleaning having an intermediate level of the improvement ability. Further, in the purge, the suction processing is executed on all the nozzles 55a by the negative pressure. Therefore, the ink in the nozzles 55a is easily discharged, and the amount of ink that may be discharged is larger than that in the flushing, and thus the ink consumption amount is increased, but the discharge accuracy of the ink is higher than that in the flushing. Therefore, the purge can be said to be cleaning having a strong improvement ability.

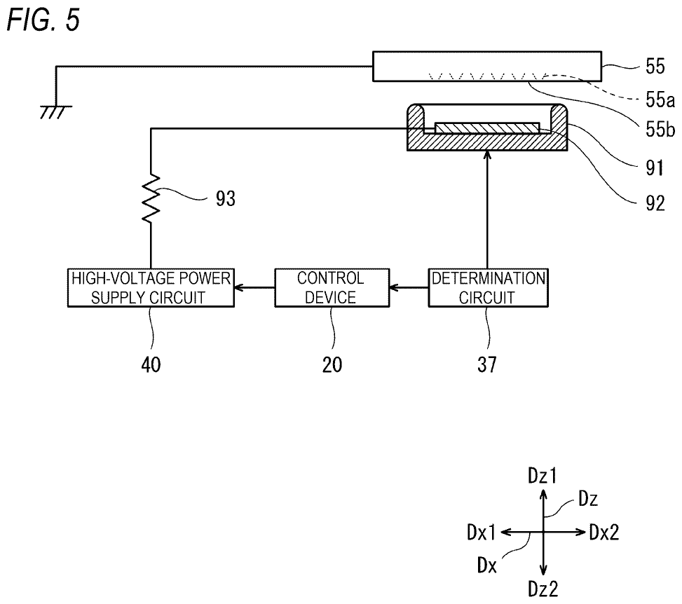

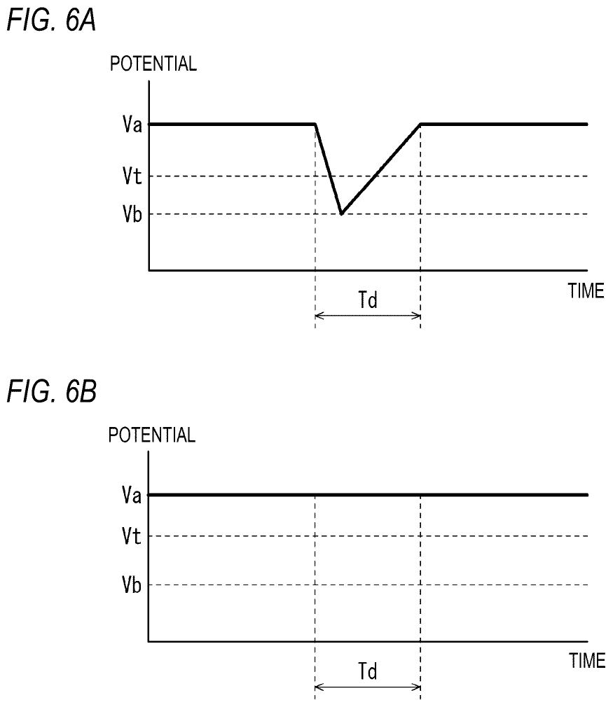

Next, criteria for determining whether to execute the first cleaning will be described. FIG. 5 is a diagram showing a configuration for executing the ejection failure detection processing. FIG. 6A is a diagram showing a change in a voltage value of a detection electrode 92 when the ink is ejected from the nozzle 55a, and FIG. 6B is a diagram showing a change in the voltage value of the detection electrode 92 when the ink is not ejected from the nozzle 55a.

As shown in FIG. 5, the plate-shaped detection electrode 92, for example, is disposed in the cap portion 91 described above. The detection electrode 92 is connected to the high-voltage power supply circuit 40 via a resistor 93. When the ejection failure detection processing is executed, a predetermined positive potential (for example, about 600 V) is applied to the detection electrode 92 by the high-voltage power supply circuit 40. On the other hand, the ejection head 55 is maintained at the ground potential. Accordingly, a predetermined potential difference is generated between the ejection head 55 and the detection electrode 92. The determination circuit 37 is connected to the detection electrode 92. The determination circuit 37 compares a potential of a signal output from the detection electrode 92 with a threshold Vt, and outputs a signal corresponding to a comparison result.

Specifically, after the liquid contacting state is switched to the liquid un-contacting state by the switching mechanism 59, the ejection head 55 is disposed at the detection position DP by the carriage 54. In this state, the ink is ejected from each nozzle 55a toward the detection electrode 92. As described above, since there is a potential difference between the ejection head 55 and the detection electrode 92, the ink ejected from the nozzle 55a is charged. In this case, as shown in FIG. 6A, until the charged ink approaches the detection electrode 92 and the ink lands on the detection electrode 92, the potential of the detection electrode 92 decreases from a potential Va when the ejection head 55 is not driven, and reaches a potential Vb lower than the potential Va. After the charged ink lands on the detection electrode 92, the potential of the detection electrode 92 gradually rises and returns to the potential Va. That is, the potential of the detection electrode 92 changes during a driving period Td of the ejection head 55. The threshold Vt is set such that Va<Vt<Vb.

On the other hand, when the ink is not ejected from the nozzle 55a, the potential of the detection electrode 92 hardly changes from the potential Va during the driving period Td of the ejection head 55 as shown in FIG. 6B. Although the positive potential is applied to the detection electrode 92 by the high-voltage power supply circuit 40 in the above description, a negative potential (for example, about −600 V) may be applied to the detection electrode 92. In this case, contrary to the above, when the ink is ejected from the nozzle 55a toward the detection electrode 92, the potential of the detection electrode 92 rises from the potential Va until the charged ink approaches the detection electrode 92 and the ink lands on the detection electrode 92, and after the ink lands on the detection electrode 92, the potential of the detection electrode 92 gradually decreases and returns to the potential Va.

The determination circuit 37 compares the potential of the voltage signal output from the detection electrode 92 with the threshold Vt during the driving period Td of the ejection head 55, and outputs a determination signal corresponding to the comparison result to the control device 20. The control device 20 detects the ejection failure of at least one nozzle 55a on the nozzle surface 55b for each nozzle 55a based on the determination signal. The control device 20 counts the number of nozzles 55a having the ejection failure in a result of the detection processing. In a configuration in which laser light is radiated on the ink droplets discharged from the nozzle 55a before reaching the cap 51 (or the cap portion 91) and light reception intensity (transmittance) of the laser light after the radiation is detected, the ejection failure detection processing may be executed based on the detection result.

The control device 20 determines whether to execute the first cleaning based on the detection result. In this case, for example, the control device 20 determines whether to execute the first cleaning in accordance with the number of nozzles 55a in which the ejection failure occurs counted as described above. At this time, the control device 20 compares the number of nozzles 55a related to the ejection failure with a predetermined first threshold, and when the number of nozzles 55a related to the ejection failure is the first threshold or more, the control device 20 determines that the first cleaning is necessary. When the number of nozzles 55a related to the ejection failure is less than the first threshold, the control device 20 determines that the first cleaning is unnecessary. When it is determined that the first cleaning is necessary, the control device 20 causes the first cleaning portion CL1 to execute the first cleaning. When it is determined that the first cleaning is unnecessary, the control device 20 does not cause the first cleaning portion CL1 to execute the first cleaning.

The first cleaning includes, as the plurality of types of first cleaning, the purge, the flushing, and the wiping as described above. The control device 20 determines the first cleaning to be executed among the plurality of types of first cleaning according to the detection result of the ejection failure and causes the first cleaning portion CL1 to execute the first cleaning.

For example, the control device 20 determines the first cleaning to be executed among the plurality of types of first cleaning according to a position distribution of the nozzles 55a in which the ejection failure occurs as a result of the ejection failure detection processing. For example, in the ejection failure detection processing, the position of each nozzle 55a at the position of the nozzle surface 55b is stored in advance, and the control device 20 recognizes the position of the nozzle 55a where the ejection failure occurs. At this time, for example, a mode in which a predetermined number or more of nozzles 55a having the ejection failure gather in a state of being adjacent to each other is acquired by the control device 20 as the position distribution. In this case, for example, the control device 20 compares the size of a range related to the position distribution (for example, an area of a region surrounded by a line connecting the nozzles 55a on an outermost side in the case where the nozzles 55a having the ejection failure are present in a gathered way in a state of being adjacent to each other) with a predetermined second threshold, and when the size is equal to or greater than the second threshold, the control device 20 can determine the purge having the strong improvement ability as the first cleaning to be executed. Alternatively, instead of the area, the control device 20 may compare a length of a line segment connecting the nozzles 55a in the case where the nozzles 55a having the ejection failure are present in a gathering way in a state of being adjacent to each other with the second threshold. At this time, a line segment may be defined by the outermost nozzles 55a among the nozzles 55a having the ejection failure. In addition, when the size is less than the second threshold, the control device 20 can determine the flushing or the wiping having the weaker improvement ability than the purge as the first cleaning to be executed. When the purge is determined as the first cleaning, the control device 20 causes the pump 52 serving as the first cleaning portion CL1 to execute the purge in the liquid un-contacting state and the covered state after the non-covered state is switched to the covered state by the switching mechanism 59. The control device 20 may change a suction force of the pump 52 in the purge according to the detection result. In this case, the control device 20 increases the suction force by increasing a driving time of a motor of the pump 52, and decreases the suction force by reducing the driving time. Further, the control device 20 can increase the suction force by increasing the rotation speed of the motor of the pump 52, and can decrease the suction force by decreasing the rotation speed. Accordingly, the ejection function is improved by an appropriate suction force corresponding to the detection result.

Alternatively, the control device 20 may determine the first cleaning to be executed among the plurality of types of first cleaning according to the number of times the first cleaning is executed, instead of the position distribution of the nozzles 55a in which the ejection failure occurs. In this case, when the number of times the first cleaning is executed is less than a third threshold, for example, the first cleaning having the strong improvement ability is executed by the first cleaning portion CL1. On the other hand, when the number of times the first cleaning is executed is equal to or greater than the third threshold, for example, an error is displayed on the display unit 29. Accordingly, the ejection function corresponding to the number of times the first cleaning is executed is appropriately improved, and unnecessary repetition of the first cleaning is avoided by executing the error display when the ejection function is not improved even if the first cleaning is repeated.

In the present embodiment, the control device 20 causes the second cleaning portion CL2 to execute the second cleaning after the liquid contacting state is switched to the liquid un-contacting state by the switching mechanism 59 and before the ejection failure detection processing is executed as described above. Accordingly, the cleaning liquid that has entered the nozzle 55a by the liquid contact is discharged by the second cleaning. Accordingly, the ejection failure of the nozzle 55a is improved before the ejection failure detection processing is executed, and a possibility that the first cleaning becomes unnecessary increases. When the ejection function is not improved by the second cleaning, the ejection function may be improved by the first cleaning.

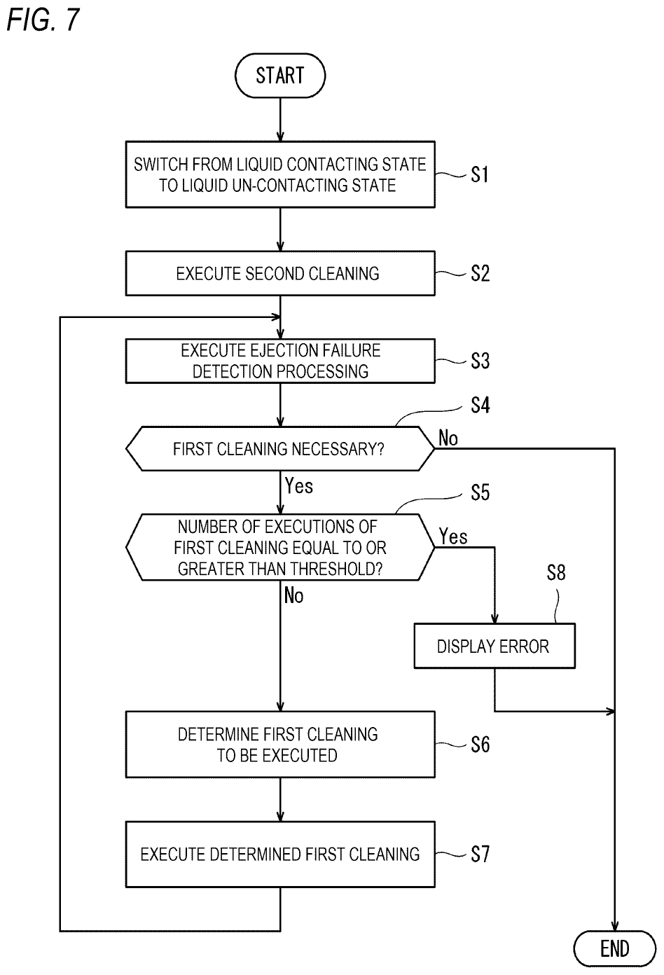

FIG. 7 is a flowchart showing a flow of the first cleaning and the second cleaning in the printing apparatus 100. As shown in FIG. 7, when receiving a switching instruction based on a program, for example, the control device 20 switches the liquid contacting state to the liquid un-contacting state by the switching mechanism 59 (step S1).

Next, the control device 20 causes the second cleaning portion CL2 to execute the second cleaning (step S2). In this case, for example, when a non-ejection time (non-printing time) during which ink droplets are not ejected from the nozzles 55a is equal to or longer than a predetermined time, the control device 20 can execute the flushing having the relatively strong improvement ability as the second cleaning. Further, when the non-ejection time (non-printing time) is less than the predetermined time, the control device 20 can execute the wiping with the relatively weak improvement ability as the second cleaning. After the liquid contacting state is switched to the liquid un-contacting state, both the wiping and the flushing may be executed as the second cleaning.

Next, the control device 20 executes the ejection failure detection processing as described above (step S3). Then, the control device 20 determines whether execution of the first cleaning is necessary based on the result of the detection processing (step S4). In this case, the control device 20 determines whether to execute the first cleaning in accordance with, for example, the number of nozzles 55a in which the ejection failure occurs.

When it is determined that the first cleaning is necessary (Yes in step S4), the control device 20 determines whether the number of times the first cleaning is executed is equal to or greater than the third threshold (step S5). In this case, the number of times the first cleaning is executed is counted every time the first cleaning is completed. On the other hand, when it is determined that the first cleaning is unnecessary (No in step S4), the processing ends.

When the number of times of execution of the first cleaning is less than the third threshold in the processing of step S5 (No in step S5), next, the control device 20 determines the first cleaning to be executed (step S6). In this case, for example, the control device 20 determines the first cleaning to be executed according to the size of the range related to the position distribution of the nozzles 55a in which the ejection failure occurs or the number of times the first cleaning is executed. On the other hand, when the number of times the first cleaning is executed is equal to or greater than the third threshold in the processing of step S5 (Yes in step S5), the control device 20 causes, for example, the display unit 29 to display the error (step S8), and ends post-processing.

After the processing of step S6, the control device 20 causes the first cleaning portion CL1 to execute the determined first cleaning (step S7). After the processing of step S7 ends, the control device 20 returns to the processing of step S3 and repeats the subsequent processing. The number of times the first cleaning is executed is reset when it is determined that the first cleaning is unnecessary or when the error is displayed.

As described above, according to the printing apparatus 100 of the present embodiment, the necessity of the first cleaning is determined by the control device 20 based on the detection result of the ejection failure of the nozzle 55a. When it is determined that the first cleaning is necessary, the first cleaning is executed by the first cleaning portion CL1, and when it is determined that the first cleaning is unnecessary, the first cleaning is not executed. Accordingly, the amount of the ink discharged from the inside of the nozzle 55a is reduced compared with a case where cleaning such as purge processing is uniformly executed regardless of the presence or absence of the ejection failure of the nozzle. Accordingly, the consumption of the ink may be suppressed. In addition, since the liquid contacting processing is periodically executed in the printing apparatus 100, it is possible to suppress the thickening of the ink in the nozzle 55a. Accordingly, the ink in the nozzle 55a is easily discharged in the first cleaning (the purge or the like) executed after the liquid contacting state is formed. Therefore, the discharge amount of the ink may be reduced compared with a case where the ink in the nozzles 55a is forcibly discharged without the nozzle surface 55b coming into contact with the liquid surface. Thus, the consumption of the ink is further suppressed. In particular, in a case where the white ink containing pigment particles and having a high thickening property is used, when, for example, the purge is executed as the first cleaning, the amount of the ink discharged in the purge increases, and thus the consumption of the ink becomes remarkable. However, as described above, since the first cleaning is executed only when necessary without being executed uniformly, the consumption of the white ink may be suppressed.

In the present embodiment, the second cleaning is executed by the second cleaning portion CL2 after the liquid contacting state is switched to the liquid un-contacting state by the switching mechanism 59 and before the ejection failure detection processing of the nozzle 55a is executed. In this case, the liquid that has entered the nozzle 55a by the liquid contact is discharged by the second cleaning. Accordingly, the ejection failure is improved before the ejection failure detection processing is executed, and the possibility that the first cleaning becomes unnecessary increases. When the ejection function is not improved by the second cleaning, the ejection function may be improved by the first cleaning.

Further, in the present embodiment, the first cleaning includes the cleaning that has the stronger improvement ability of the ejection function of the nozzle 55a than the second cleaning. In this case, for the nozzle 55a whose ejection function is not improved by the second cleaning, the ejection function may be improved by the first cleaning.

Further, in the present embodiment, the control device 20 determines the first cleaning to be executed among the plurality of types of first cleaning according to the detection result of the ejection failure, and the first cleaning is executed by the first cleaning portion CL1. Accordingly, among the plurality of types of first cleaning, the first cleaning having, for example, the strong or weak improvement ability of the ejection function is determined by the control device 20 according to the detection result of the ejection failure, and the determined first cleaning is executed by the first cleaning portion CL1.

Further, in the present embodiment, as the detection result of the ejection failure, the first cleaning to be executed is determined by the control device 20 according to, specifically, the position distribution of the nozzles 55a in which the ejection failure occurs. In this case, if the position distribution of the nozzles 55a where the ejection failure occurs is over a wide range, the first cleaning having the strong improvement ability may be executed by the first cleaning portion CL1. On the other hand, if the position distribution of the nozzles 55a is in a narrow range, the first cleaning having the weak improvement ability may be executed by the first cleaning portion CL1. Accordingly, the ejection function corresponding to the position distribution of the nozzles 55a in which the ejection failure occurs is appropriately improved.

Further, in the present embodiment, after the non-covered state is switched to the covered state by the switching mechanism 59, as the first cleaning, the purge is executed by the first cleaning portion CL1 in the liquid un-contacting state and the covered state. In this case, the negative pressure is generated in the cap 51 by the purge, and the ink in the nozzle 55a is discharged. Accordingly, the first cleaning with the strong improvement ability is executed.

The present invention is not limited to the above-described embodiment, and modifications can be adopted without departing from the gist of the present invention. For example, it is as follows.

In the above-described embodiment, the predetermined image is formed on the print medium W by repeating the pass of forming the dots along the first direction Dx1 and the operation of conveying the print medium W in the conveyance direction Dy1, but a printing method is not limited thereto. In another printing method, processing of moving the carriage supporting the ejection head to a predetermined position in the first direction Dx and processing of ejecting the ink droplets from the ejection head while reciprocating the platen supporting the print medium in the second direction Dy in this state may be alternately repeated.

In the above-described embodiment, the second cleaning is executed by the second cleaning portion CL2 after the liquid contacting state is switched to the liquid un-contacting state by the switching mechanism 59 and before the ejection failure detection processing is executed as described above, but the second cleaning is not an essential step.

In the above-described embodiment, the control device 20 determines the first cleaning to be executed among the plurality of types of first cleaning according to the position distribution of the nozzles 55a in which the ejection failure occurs or the number of times of executing the first cleaning, but the present invention is not limited thereto. The control device 20 may use the number of nozzles 55a in which the ejection failure occurs as a reference when determining the first cleaning to be executed among the plurality of types of first cleaning. In this case, as described above, a fourth threshold larger than the first threshold used when determining whether to execute the first cleaning is used. That is, the reference threshold is set to be small in relation to the determination of the necessity of the first cleaning, and the reference threshold is set to be large in relation to the determination of the type of the first cleaning to be executed. In this case, the control device 20 compares the number of nozzles 55a related to the ejection failure with the predetermined fourth threshold, and when the number of nozzles 55a related to the ejection failure is equal to or greater than the fourth threshold, the control device 20 can determine the purge with the strong improvement ability as the first cleaning to be executed. Further, when the number is less than the fourth threshold, the control device 20 can determine the flushing or the wiping having the weaker improvement ability than the purge as the first cleaning to be executed. Accordingly, the ejection function corresponding to the number of nozzles 55a in which the ejection failure occurs is appropriately improved.

Further, in the above embodiment, the position of the cap 51 when the covered state is formed is the same as the position of the cap 51 when the liquid contacting state is formed, but the present invention is not limited thereto. When the condition that the nozzle surface 55b is in contact with the liquid is satisfied in the formation of the liquid contacting state, the nozzle surface 55b may not be covered with the cap 51.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing apparatus comprising:
an ejection head having a nozzle surface provided with a plurality of nozzles;
a switching mechanism configured to switch between a liquid contacting state in which a predetermined liquid surface is in contact with the nozzle surface and a liquid un-contacting state in which the nozzle surface is separated from the liquid surface during non-ejection when an ink is not ejected from the nozzles;
a first cleaning portion configured to execute first cleaning, which is cleaning for improving an ejection function of the nozzles; and
a control device, wherein
the control device is configured to
switch the liquid contacting state to the liquid un-contacting state by the switching mechanism,
detect an ejection failure of at least one of the nozzles in the nozzle surface after the switching to the liquid un-contacting state,
determine whether the first cleaning is necessary based on a detection result,
cause the first cleaning portion to execute the first cleaning when it is determined that the first cleaning is necessary, and
not cause the first cleaning portion to execute the first cleaning when it is determined that the first cleaning is unnecessary.

2. The printing apparatus according to claim 1, further comprising:
a second cleaning portion configured to execute second cleaning, which is cleaning for improving an ejection function of the nozzles, wherein
the control device is configured to cause the second cleaning portion to execute the second cleaning after the liquid contacting state is switched to the liquid un-contacting state by the switching mechanism and before the processing of detecting the ejection failure of the nozzles is executed.

3. The printing apparatus according to claim 2, wherein
the first cleaning includes cleaning that has a stronger improvement ability of the ejection function than the second cleaning.

4. The printing apparatus according to claim 1, wherein
the first cleaning includes a plurality of types of first cleaning, and
the control device is configured to determine first cleaning to be executed among the plurality of types of first cleaning according to the detection result and causes the first cleaning portion to execute determined first cleaning.

5. The printing apparatus according to claim 4, wherein
the control device is configured to determine the first cleaning to be executed according to the number of the nozzles in which the ejection failure occurs as the detection result.

6. The printing apparatus according to claim 4, wherein
the control device is configured to determine the first cleaning to be executed according to a position distribution of the nozzles in which the ejection failure occurs as the detection result.

7. The printing apparatus according to claim 1, wherein
the first cleaning includes a plurality of types of first cleaning, and
the control device is configured to determine first cleaning to be executed among the plurality of types of first cleaning according to the number of times the first cleaning is executed and causes the first cleaning portion to execute determined first cleaning.

8. The printing apparatus according to claim 1, wherein
the switching mechanism executes switching between a covered state in which the nozzle surface is covered by the switching mechanism and a non-covered state in which the nozzle surface and the switching mechanism are separated from each other, and
the control device is configured to cause the switching mechanism to switch from the non-covered state to the covered state, and then causes the first cleaning portion to execute a purge in which an ink is forcibly discharged from the nozzle in the liquid un-contacting state and the covered state as the first cleaning.

9. The printing apparatus according to claim 8, wherein
the first cleaning portion includes a pump that generates a negative pressure in the switching mechanism when the purge is executed, and
the control device is configured to change a suction force of the pump in the purge according to the detection result.
